(19) United States
(12) Patent Application Publication
(10) Pub. No.: US 2015/0199307 A1
(43) Pub. Date: Jul. 16, 2015

(54) Pluggable Architecture For Optimizing Versioned Rendering of Collaborative Documents

(71) Applicants: Eric Zhang, Jersey City, NJ (US); James Watts, New York, NY (US); Michael Verrilli, New York, NY (US)

(72) Inventors: Eric Zhang, Jersey City, NJ (US); James Watts, New York, NY (US); Michael Verrilli, New York, NY (US)

(73) Assignee: Google Inc., Mountain View, CA (US)

(21) Appl. No.: 13/569,584

(22) Filed: Aug. 8, 2012

(51) Int. Cl. G06F 17/24; G06F 17/00

(52) U.S. Cl. CPC G06F 17/2235; G06F 17/2247; G06F 17/24

(57) ABSTRACT

Techniques are shown for enabling a network system to receive collaborative edits from users at a first front end URL, and receive viewing requests from users at a second front end URL. The edits are processed using operational transformation techniques and stored as sets of edits. Multiple pluggable flattening utilities retrieve the sets of edits and convert them into structured data documents specifically tailored for different client devices or online services. The structured data documents are stored and retrieved by rendering servers upon receiving viewing requests. This Abstract is submitted with the understanding that it will not be used to interpret or limit the scope or meaning of the claims.

### BACKGROUND

Web pages or other documents may be created by users on client devices to be accessible to other users over a network such as the Web. Web pages generally contain structured data documents such as HyperText Markup Language (HTML) documents, eXtensible Markup Language (XML) documents, JavaScript scripting language, etc. Creating and editing these structured data documents may require specialized knowledge of the programming or scripting language.

### SUMMARY

Techniques are disclosed to enable an online document editing engine to accept collaborative inputs from editors working concurrently on the same document, store the set of collaborative editing inputs received, and process the same set of collaborative inputs by one of a plurality of different flattening utilities. A flattening utility, or flattener converts the set of edits into a structured data document that is customized for rendering and display on a particular client device, online service, third-party web site, or other location. The structured data output produced by each flattening utility can be a HyperText Markup Language (HTML) document for a web site, or other structured data documents.

A network system according to various implementations of this disclosure enables collaborative and scalable editing and viewing of online content. A first data store receives and stores collaborative edits to user-created online content. A second data store receives and stores structured data documents created from the collaborative edits to the user-created online content. A browser, browser extension, or other application on a client device renders and displays the structured data documents retrieved from the second data store when a user sends a viewing request to a rendering server. An editing server receives and processes the collaborative edits to the user-created online content using operational transformation techniques and sends the processed collaborative edits to the first data store. An editing request router directs the collaborative edits from multiple collaborating editors to an appropriate editing server. A flattening utility, or flattener retrieves a set of collaborative edits to user-created online content from the first data store, converts the set of collaborative edits into a structured data document, and stores the structured data document in the second data store. The rendering server receives a plurality of viewing requests from viewers and retrieves an appropriate structured data document from the second data store. A client viewing device renders and displays the structured data document.

Implementations may include corresponding systems, apparatus, and computer programs, configured to perform the actions of the methods, encoded on computer storage devices. This Summary is not intended to introduce key features or essential features of the claimed subject matter, but merely provides a selection of concepts that are further described in the Detailed Description. Further implementations, features, and advantages, as well as the structure and operation of the various implementations are described in detail below with reference to accompanying drawings.

### BRIEF DESCRIPTION OF THE FIGURES

Implementations are described with reference to the accompanying drawings. In the drawings, like reference numbers may indicate identical or functionally similar elements. The drawing in which an element first appears is generally indicated by the left-most digit in the corresponding reference number.

FIG. 1 is a schematic diagram of a system in accordance with one or more implementations of the disclosure.

FIG. 2 is a schematic diagram illustrating features in accordance with an implementation of the disclosure.

FIG. 3 is a schematic diagram illustrating features in accordance with another implementation of the disclosure.

FIG. 4 is a flow chart illustrating techniques employed in accordance with one or more implementations of the disclosure.

FIG. 5 is a schematic diagram of a computer system employed in accordance with one or more implementations of the disclosure.

### DETAILED DESCRIPTION

A need exists to allow multiple users to collaborate and edit web pages or other documents accessible over a network such as the Web. As the numbers of users editing an online-accessible document increases, the server on which the document is hosted can be overloaded by the number of queries and other input. Furthermore, structured data documents such as HyperText Markup Language (HTML) documents, eXtensible Markup Language (XML) documents, JavaScript scripting language, etc., commonly used on web sites, can also be difficult for an average user to edit without specialized knowledge of the programming or scripting language.

Collaborative editing of a document over a network can involve multiple users with editing capabilities and the proper permissions (hereinafter referred to as “editors”) working from multiple client devices that are communicatively coupled over a network, such as the Internet, to one or more editing servers. The editing can include multiple requests for changes or mutations to a document or a document object model (DOM)—a cross-platform and language-independent convention for representing and interacting with objects in HyperText Markup Language (HTML), eXtensible HyperText Markup Language (XHTML), and Extensible Markup Language (XML).

A first data store communicatively coupled to the editing server can store these collaborative changes, or mutations, as a set of edits to a particular online document. The first data store may store all of the mutations or changes made to the document by all collaborating editors in sequence. For example, a mutation log may include a record of changes to a document that include adding a particular character at a particular position in the document, removing a character, changing the style of all or a portion of the document, bolding some text, changing the font of some text, adding or removing a hypertext link (i.e., hyperlink) pointing to other web pages, adding or removing gadgets, images, objects, etc.

The technology of operational transformation coordinates concurrent changes made to a document by different collaborating editors, resolves any conflicts that may occur, and merges the changes into a set of approved edits. As change requests come in from different editors working collaboratively on the same document, operational transformation keeps track of the substance and timing of the separate operations that are being performed on the document. As one example, if an editing change request was fulfilled to delete a character from a certain position in a group of characters, and then subsequently another editing change request attempted to move that previously deleted character from that certain position to another position, operational transformation techniques would prevent such an edit since the character had already been deleted from that particular position. Another example could occur when two simultaneous inserts are made by different editors at different indexes in a document. Operational transformation could cause one of the indexes to be automatically shifted to accommodate the other insert. Storing a record of the mutations enables functionality such as restoring a document or document object model to any previous state or condition it was in before certain changes were made by undoing certain mutations.

Techniques that include storing all of the mutations made by multiple collaborating editors as a bundle of JavaScript code can slow down the editing process. Rather than sending a finalized, structured text document, such as an HTML document for a web page, to the client, the client may render the page using the bundle of code representing the complete record of mutations. A mutation log storing all of the editorial changes made by the multiple editors may also include many old and currently irrelevant actions, such as when a character was initially added to the document, and then later removed.

In the case of an online web site creation or editing service, many potential requests for editing or viewing an existing or newly created web site, or documents on the web site, may come into the data center for the online or network system over a communication network such as the Internet. The data center may include a plurality of servers capable of receiving such requests. Each of the multiple servers can be communicatively coupled to a data store that includes the web site information, including data for web pages, e.g., HTML (HyperText Mark-up Language) documents, XML (eXtensible Mark-up Language) documents, associated JavaScript plug-ins, JavaScript Object Notation (JSON), etc., and a mutation log of the substance and timing of all the collaborative editorial changes made to the documents. By routing the many incoming requests to different ones of the plurality of servers, the speed of the results can be scalable, e.g., one thousand requests could be routed to one thousand different machines at the same time, each of which could access the same data store and return the same results simultaneously. A potential problem with routing multiple incoming requests to multiple machines is that this technique does not lend itself to collaboration between multiple editors working simultaneously on a single document.

When multiple editors are collaborating online to edit a single document, if all the requests from the multiple editors are routed to the same machine, all editors get the edits made by other collaborating editors right away because all of the processing is occurring on a single machine. However, a potential problem with this technique of routing all requests to a single machine is that there are limits on the scalability of this technique. For example, if a thousand editors, or some other large number of editors are trying to hit the same machine with editing requests for a single document, there is a likelihood that the machine will not be able to handle so many simultaneous requests.

In accordance with various implementations of this disclosure, techniques are provided for facilitating a collaborative experience for users creating or editing documents such as structured data documents, e.g., HTML documents for web pages, while maintaining the scalability of the experience and allowing many users to provide input requests and view the edited document. The techniques disclosed also include providing for the automatic preprocessing and configuration of a structured data document for rendering in different ways, on different online services, and/or on different client devices having different display capabilities or attributes.

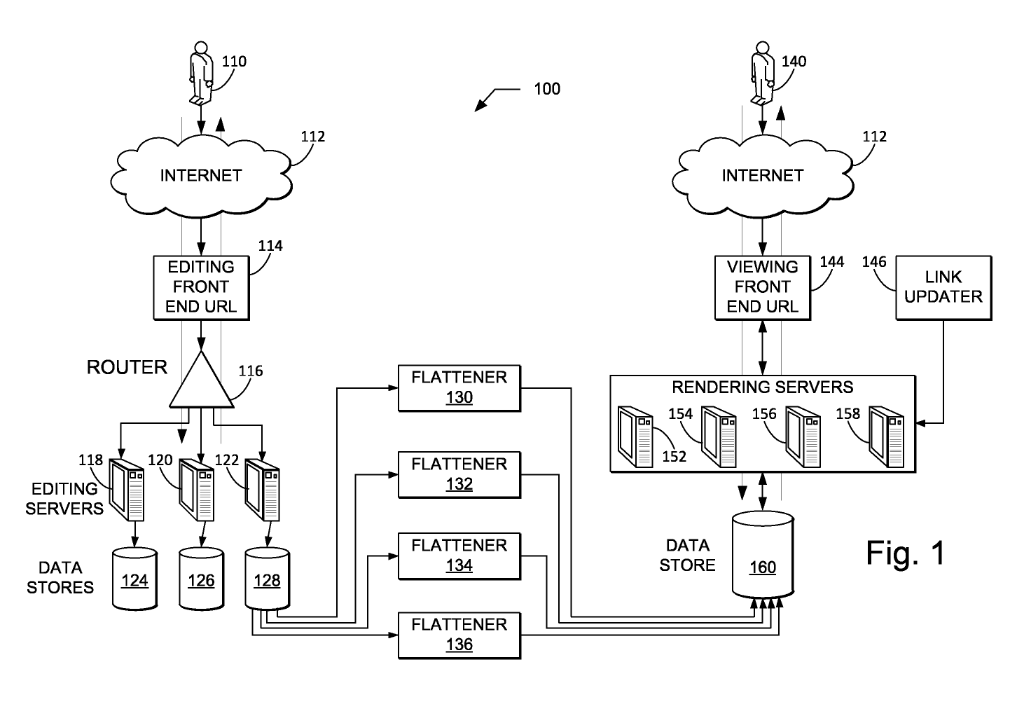

As shown in FIG. 1, editors of documents and viewers of those documents can be communicatively coupled to different front end servers on a network system over different communication paths. The editor is shown communicating through a first path with the network system front end computing device over a communication network such as the Internet. A uniform resource locator (URL) for incoming editing requests can be provided and made available to users with editing permissions or proper access control attributes, and if desired, in accordance with authentication protocols. A separate URL for incoming viewing requests can also be provided to direct viewing requests along a separate communication path and to different rendering servers from the editing servers. The network system front end computing device may direct a request from an editor through a request router to a particular editing server selected from a plurality of editing servers on the network system. The request router directs an editing request for a particular document to the editing server that is handling the creation and/or editing of the particular document the editor is working on. Each editing server is connected to a corresponding data store that is not shared with other editing servers.

One or more editors make collaborative changes to a particular document having a document identification (ID), and each of those collaborative changes, or mutations, are stored in the data store associated with the particular editing server on which the document is being handled. Each document ID can be hashed so that each document ID corresponds to a number. The documents that are being edited by one or more editors can be distributed across however many servers or computing machines there are designated for the editing functions on the network system. As the number of documents increases, more editing servers can be added in order to handle the potential number of editing requests that come in for each document.

Users who are only viewing the document on the network system, and are not providing editing requests, can communicatively connect over a communications network such as the Internet to a network system front end at a different uniform resource locator (URL) from the URL for incoming editing requests. The network system viewing front end directs requests from viewers to the appropriate renderer for the particular client device the viewer is using.

When an editor decides that the document they are working on is ready to be published and made available to other users on the network system, a flattener can gather together all of the up-to-date mutations or changes corresponding to all of the edits that have been made on the document, and then convert all of those mutations into a structured text document such as an HTML document for presentation on a web page. A flattener, as used herein, can designate a module, utility, or mechanism for taking the stack of mutations and converting that stack into a structured data document such as an HTML document for presentation on a web page.

Depending on the client devices on which the structured text document or documents will be rendered and displayed, a plurality of flatteners can be provided, each designed to flatten the mutations or edits appropriately for a particular type of client device or online service on which the document will be displayed. For example, the arrangement of objects and features contained within a document, such as headers, sidebars, images, etc., may be different for rendering and displaying on a smartphone, than on a tablet, a laptop, or a PC. Each of the flatteners can include pluggable architecture, such as software plug-ins or extensions, which allow for duplication of much of the code for the different flatteners, with the pluggable architecture being changeable to adapt the flattener for functionality that creates output for each of the different types of client devices. Additionally, one or more flatteners can be provided to incorporate specific formatting, styles, hyperlinks, feature buttons, gadgets, or other attributes specific to the particular online service where the collaboratively edited, structured data document will be included.

As shown in FIGS. 1, 2, and 3, multiple flatteners retrieve a set of edits from a data store and convert the set of edits into different versions of a structured data document for display on different client devices or online services. Editors only have to provide one set of edits for one version of a document, and the multiple flatteners automatically convert that one version into the different formats, etc. that may be required for display on different client devices.

When one or more collaborating editors decide that the edits are sufficient, and a version of the document they are collaborating on is ready to be published, the set of edits for the version that is to be published is stored in one location in a data store designated for receiving edits from an associated editing server. The various flatteners communicatively coupled to that data store can automatically retrieve the same set of edits (or mutation log) for a particular document, and automatically convert that set of edits into a plurality of appropriate final structured data documents for display on different client devices or online services. Each time one or more editors decide that a set of edits is ready for publishing, the various flatteners can retrieve that set of edits from the data store communicatively coupled to the editing server. Each flattener converts the set of edits into a customized, structured data document appropriate for a particular client device or online service, and sends that structured data document to a data store that is communicatively coupled to the rendering servers. As a result, structured data documents appropriate for different client devices and/or online services are prepared and stored ahead of when a client sends a viewing request to the rendering servers. This makes it possible to quickly perform a search for a desired document, and to quickly retrieve the desired document on a particular client device. The separation of communication paths and servers for editors and viewers also allows for rapid and responsive collaboration between the editors and scalability to handle large numbers of viewers at the same time.

In addition to automatically flattening and converting a set of collaborative edits or mutations into different versions of a structured data document appropriate for rendering and display on different devices, the various flatteners may also include pluggable architecture that automatically incorporates different page styles, gadgets, etc. to a document depending on the particular service or web site where the document will be presented and made available for rendering and display on a client device. As one, non-limiting example of different renderings that may be produced by different flatteners, one flattener may provide a web page with a visual style that includes a white background with black lettering, while a different flattener may provide the same web page with a style that includes a black background with green lettering. Another flattener may automatically include certain gadgets, hyperlinks, metatags, etc. appropriate for the particular online service where the document will be presented.

In various alternative implementations one or more flatteners can be provided, where each flattener is developed for different services or web sites, and multiple flatteners working from the same set of collaborative edits stored in a data store automatically convert the edits through operational transformation into structured data documents suitable for rendering and displaying on different client devices or online services.

In other alternative implementations a flattener can be configured to retrieve a set of edits provided by various editors and including JavaScript or other computer programming code developed by the editors. The flattener can convert the provided code, or sandbox the code when desirable, in order to isolate any potentially harmful code from the set of edits. This feature provided by the flattener can automatically process any sets of edits stored in the data store to prevent the propagation of any harmful code, cookies, or other undesirable attributes that may have been included by an editor before the sets of edits are converted into a structured data document and released to the public for rendering and display on client devices.

The outputs from each of the flatteners can be automatically processed at the point in time when one or more editors make the decision to publish the document they have been working on. Each flattener produces a structured data document from a set of edits, with the document configured specifically for a particular client device, online service, third-party web site, etc. Each specifically configured and customized structured data document can then be stored in a data store, ready for rendering and displaying by a client device.

A viewer desiring to display a collaboratively edited and configured structured data document on their client device sends a viewing request to a viewing front end URL that is separate from the editing front end URL, and communicatively coupled to one or more rendering servers operatively configured for rendering the document for the particular browser the viewer is using, and display by the user interface (UI) of the client device. Providing a separate communication path and separate servers for incoming editing requests and for viewing requests facilitates collaborative editing of an online document, while preserving scalability of the viewing process. In many situations the number of collaborating editors will be relatively small and easily handled by a designated editing server containing the document that is being edited. At the same time, a large number of viewing requests can be accommodated by directing them along a separate communication path to a separate rendering server.

A structured data document created and edited for display on various client devices, online services, third-party web sites, etc., may also include one or more hypertext links (hyperlinks), which connect to other sites or web pages from within the document. The online system can store page identifications (IDs) for the web pages these hyperlinks connect to, rather than actually storing the hyperlinks themselves. One of the functions that can be performed by the flatteners is to convert each hyperlink in a document to the actual page ID pointed to by the hyperlink. An advantage to storing the page IDs rather than the actual hyperlinks is that when a page is moved from one location to another within a web site created and edited by one or more collaborating editors, all of the hyperlinks are automatically updated.

A flattener performs functionality such as customized configuring of a structured data document for rendering on a particular client device at the page level rather than at the level of the entire web site on which that page will appear. Therefore if a user desires to move a page from one location to another on a web site, an update of all of the hyperlinks provided on a page using the flatteners to achieve this goal would require rerunning the flattener on every page for that site.

An alternative to updating all of the hyperlinks provided on a page using a flattener is to provide another pluggable piece of architecture, such as a link updater, into the rendering servers, or communicatively coupled with the rendering servers. The link updater, or other pluggable and customized piece of architecture provided at the rendering server, can perform last minute updates to documents after they are retrieved from the data store and before they are rendered and displayed on a client device.

The link updater would provide desired updates to the collaboratively edited structured data document retrieved from a data store at the point when a viewer sends a viewing request to the rendering server. As one illustrative implementation, the link updater can be operatively configured to achieve the goal of updating all of the hyperlinks that may have been provided on a page that is being moved to another location on a web site. The link updater can achieve this goal by first going through the page that is being moved, identifying all of the hyperlinks on that page that point to a particular page on the web site, and resolving those hyperlinks to the corresponding page ID for the page that the hyperlinks point to. The provision of a link updater at the rendering server enables last minute updates and changes to a structured data document that has been prepared and stored for a particular client device, online service, or other web site.

In a broader implementation of pluggable architecture such as the above-described link updater, the pluggable architecture can be provided at the rendering server to accommodate any last minute changes to structured data documents before they are rendered and displayed on a client device. A mechanism may automatically insert desired content such as metatags, or other desired attributes, to every page to be displayed on a particular web site. The feature of providing customized and pluggable architecture for implementing last minute changes to rendered documents or other content provides a simple and easily changed plug-in mechanism for modifying documents viewed on various client devices.

Since the flatteners discussed above can provide several different outputs for different devices or clients, different pluggable architecture at the rendering servers, or rendering plug-ins, may be used for different outputs. A mechanism can be provided for specific flattener implementations to request specific rendering plug-ins to be run at rendering time. This could be achieved by encoding a list of desired plug-ins directly into the output from a flattener. Alternatively, the rendering plug-ins could be programmed to recognize the specific outputs that they apply to.

### EXAMPLE IMPLEMENTATION

FIGS. 1, 2, and 3 illustrate an online system 100 providing two separate communication paths for inputs received from users having editing permission (i.e., editors) 110, and viewers 140 desiring to only view the collaboratively edited documents produced by the editors 110.

The editors 110 send editing requests over a communication network 112 (illustrated as, but not limited to, the Internet) to an editing front end uniform resource locator (URL) 114. Viewers 140 send their viewing requests over a communication network 112 to a viewing front end URL 144. A router 116 distributes and directs the editing requests from editors 110 to different editing servers 118, 120, and 122, depending on which editing server is responsible for the particular document editors are creating or editing. As discussed above, each editing server can process the set of editing requests coming in for a particular document using operational transformation techniques to resolve any conflicts between the editing requests that are being collaboratively and concurrently submitted by the editors.

Editing server 118 processes sets of collaborative edits or mutations for one or more documents and then stores those processed edits in a data store 124. Similarly, edits that have been routed to editing server 120 by the router 116 are processed and stored in data store 126, and edits routed to editing server 122 are processed and stored in data store 128.

Requests from viewers 140 coming into viewing front end URL 144 can be divided amongst a plurality of rendering servers 152, 154, 156, and 158, all of which can be communicatively coupled to a data store 160. The incoming viewing requests can identify the particular type of client device, browser, online service, third-party web site, etc. making the viewing request. The rendering servers use this information to retrieve the appropriately formatted and customized structured data document from the data store 160.

FIG. 1 illustrates flatteners 130, 132, 134, and 136 communicatively coupled to receive data from data store 128 and send data to data store 160. Each flattener can be provided as substitutable or pluggable modules or architecture designed to retrieve a set of edits from the data store 128 and convert the set of edits into a structured data document ready for rendering and display by a browser on a particular client device, online service, or third-party web site. These finalized, customized, structured data documents are then stored in data store 160, and are available to the rendering servers 152, 154, 156, and 158.

As discussed above, an additional module or pluggable piece of architecture can be provided as, e.g., link updater 146, communicatively coupled to one, several, or all of the rendering servers. This feature allows for last minute updates to the structured data documents retrieved from data store 160 by the rendering servers. In one implementation, a last minute change of the location of a page on a web site can be handled by the link updater after a flattening utility has already been run to create customized structured data documents for various client devices, online services, third-party web sites, etc. Rather than having to rerun the flatteners to create a whole new batch of updated documents, the link updater can handle the updates only as needed when a viewer sends in a viewing request to the rendering servers.

### ANOTHER EXAMPLE IMPLEMENTATION

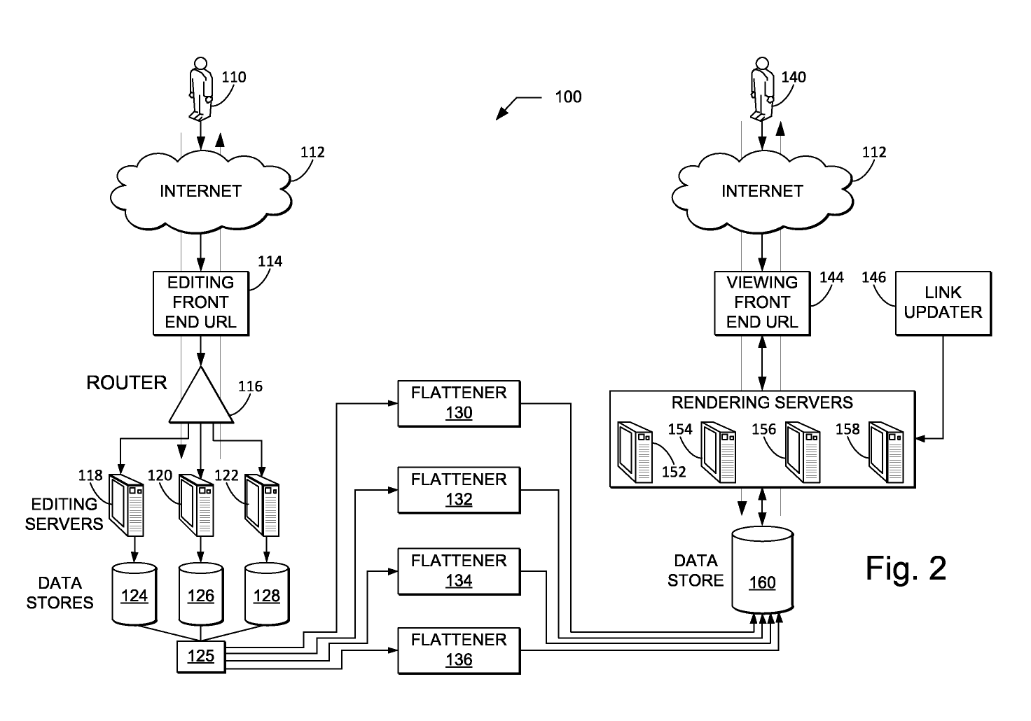

FIG. 2 illustrates an alternative implementation that differs from the described implementation of FIG. 1 above only in the inclusion of an accumulator 125 coupled to the data stores 124, 126, and 128. The flatteners 130, 132, 134, and 136 are communicatively coupled to receive data from the accumulator 125 and send data to data store 160.

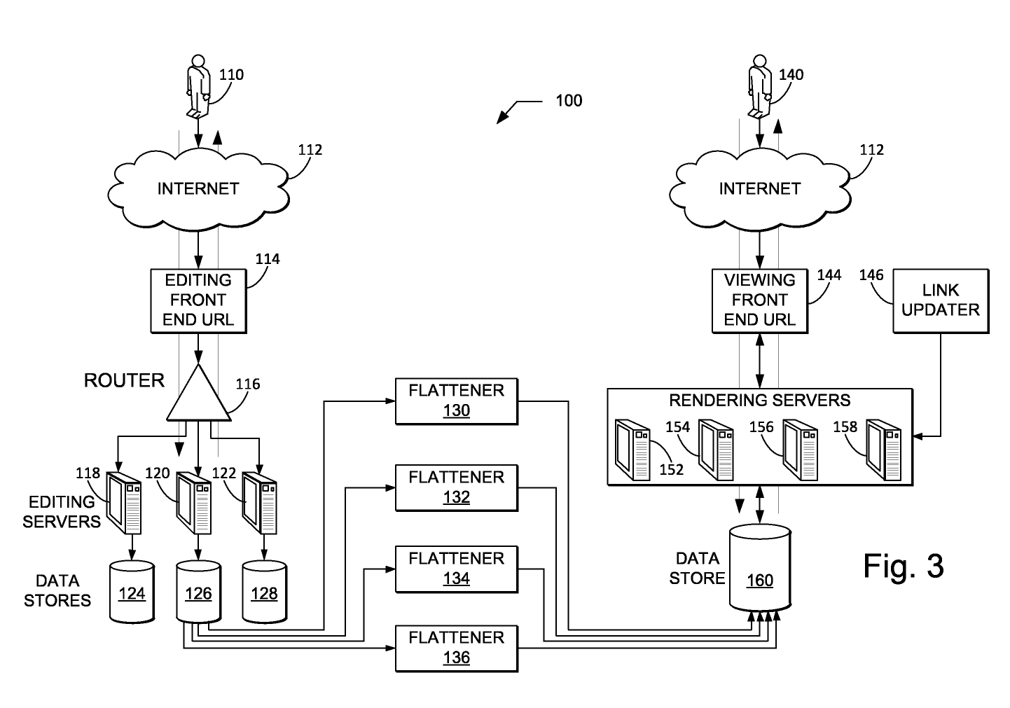

FIG. 3 illustrates yet another alternative implementation that differs from the described implementation of FIG. 1 above only in the coupling of the flatteners to data store 126. Each of the implementations illustrated in FIGS. 1, 2, and 3 provide for the flatteners to receive sets of collaborative edits from one or more data stores connected to specific editing servers. All editors working collaboratively on a particular document send their requested edits to the editing server that is handling that document, and the set of edits made to that document are stored on the particular data store connected to that editing server. This allows for each of the editors to immediately see the changes being made by other collaborating editors on a particular document. As discussed above, when one or more editors decides that a document is ready for publishing and releasing to the public, the flatteners then retrieve the sets of edits from the data stores 118, 120, and/or 122 and convert these sets of edits into customized, structured data documents, which are then stored in data store 160.

### EXAMPLE TECHNIQUES

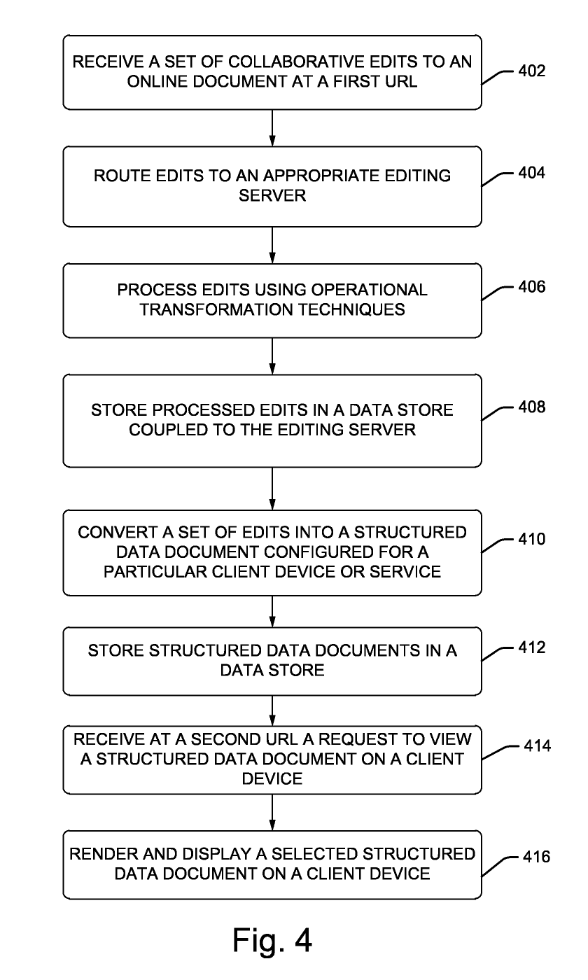

FIG. 4 illustrates the techniques employed in one or more implementations of this disclosure. At 402, a set of collaborative edits to an online document are received at a first editing URL. At 404, the edits are routed to an appropriate editing server designated for handling the document that is being collaboratively edited. At 406, an editing server processes the edits received from collaborating editors using operational transformation techniques to resolve any conflicts and merge the proposed edits into a set of edits to a document.

At 408 in FIG. 4, the set of processed edits to a document are stored in a data store connected to the editing server that processed the collaborative edits.

At 410 in FIG. 4, a set of edits retrieved from a data store are converted into a structured data document that is customized and configured for a particular client device, online service, or third-party web site. In one implementation, as shown in FIG. 1, flatteners 130, 132, 134, and 136 retrieve the sets of edits from data store 128, and process the sets of edits to convert them into structured data documents. The various structured data documents created at 410 are then stored in a data store at 412. As shown in FIG. 1, the data store for storing the structured data documents produced by the flatteners is data store 160.

At 414 in FIG. 4, requests to view a structured data document are received from client devices at a viewing URL. At 416, the structured data documents are rendered and displayed on client devices. In the implementation shown in FIG. 1, a viewer 140 has sent a viewing request to the viewing front end URL 144. Rendering servers 152, 154, 156, and 158 retrieve the appropriate structured data documents for the requesting client device from data store 160.

Implementations of the present disclosure can be carried out on a machine, a system or apparatus as part of or in relation to the machine, or a computer program product embodied in a computer readable medium executing on one or more of the machines. The one or more processors may be part of a server, client, network infrastructure, mobile computing platform, stationary computing platform, or other computing platform. Therefore, one or more of the above-described utilities, modules, or other functionalities may be embodied on a third-party server, one or more servers of the online system 100, or some combination thereof.

A processor may be any kind of computational or processing device capable of executing program instructions, codes, binary instructions and the like. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

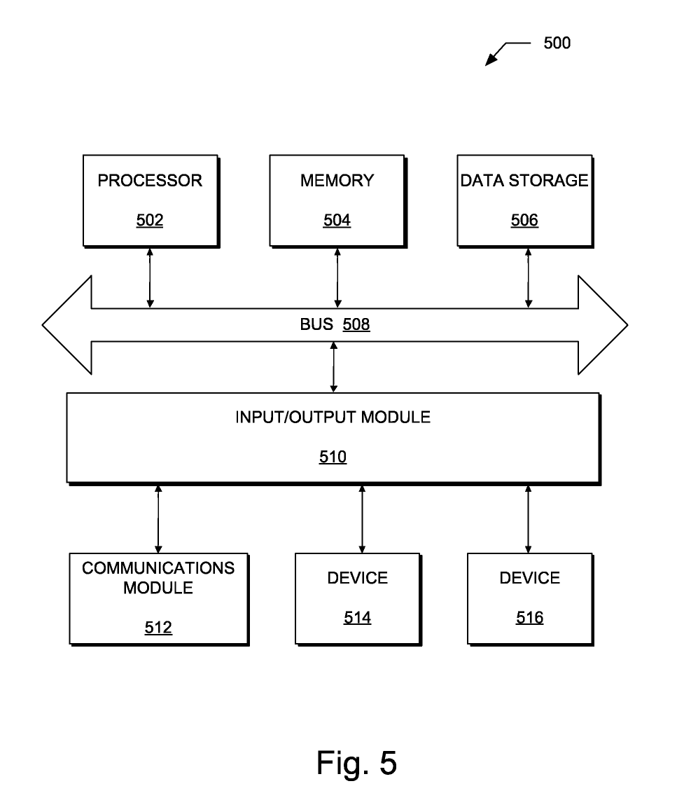

FIG. 5 is a block diagram illustrating an exemplary computer system 500 with which an online collaborative editing and rendering system 100 of FIG. 1 can be implemented. In certain aspects, the computer system 500 may be implemented using hardware or a combination of software and hardware, either in a dedicated server, or integrated into another entity, or distributed across multiple entities.

Computer system 500 includes a bus 508 or other communication mechanism for communicating information, and a processor 502 coupled with bus 508 for processing information. By way of example, the computer system 500 may be implemented with one or more processors 502. These processors may be part of any of various components shown in FIGS. 1, 2, and 3, such as the editing front end 114, viewing front end 144, router 116, editing servers 118, 120, and 122, rendering servers 152, 154, 156, and 158, and flatteners 130, 132, 134, and 136.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosed subject matter. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

A software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of the program across the network. The networking of some or all of these devices may facilitate parallel processing of a program or method at one or more location without deviating from the scope of the disclosed subject matter. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Examples of machines on which the elements described herein may be implemented may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions.

Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python).

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. The data stores 124, 126, and 128, and data store 160, shown in FIGS. 1, 2, and 3 are all examples of data storage devices used in various implementations of this disclosure. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as a CRT (cathode ray tube) or LCD (liquid crystal display) monitor, for displaying information to the user.

According to one aspect of the present disclosure, the online collaborative editing system 100, as shown in FIG. 1, can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication networks can include, but are not limited to, for example, any one or more of the following network topologies, including a bus network, a star network, a ring network, a mesh network, a star-bus network, tree or hierarchical network, or the like. The communications modules can be, for example, modems or Ethernet cards.

As discussed above, computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single embodiment or implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

1. A network system that enables collaborative and scalable editing and viewing of online content, the system comprising:
a first data store configured to receive and store collaborative edits to user-created online content;
a second data store configured to receive and store structured data documents created from the user-created online content and the collaborative edits to the user-created online content, with each structured data document configured for rendering and displaying by a browser on a client device;
an editing server operatively configured to receive and process the collaborative edits to the user-created online content using operational transformation techniques and send the processed collaborative edits to the first data store;
an editing request router operatively configured to direct the collaborative edits from multiple collaborating editors to the editing server;
a flattening utility operatively configured to retrieve a set of collaborative edits to user-created online content from the first data store, convert the set of collaborative edits into a structured data document, and store the structured data document in the second data store; and
a rendering server operatively configured to receive a viewing request to view the structured data document via a particular client viewing device from a viewer and to retrieve the structured data document from the second data store, wherein a format of the structured data document is customized for display on the particular client viewing device.

2. The network system according to claim 1, wherein:
the operational transformation techniques used by the editing server comprise resolving conflicts between incoming collaborative edits and merging the collaborative edits into a set of edits.

3. The network system according to claim 1,
wherein the flattening utility is further operatively configured to convert the set of collaborative edits into a structured data document specifically tailored for display on a particular client device.

4. The network system according to claim 1,
wherein the flattening utility is further operatively configured to convert the set of collaborative edits into a structured data document specifically tailored for display on a particular online service.

5. The network system according to claim 1,
wherein the flattening utility is further operatively configured to convert the set of collaborative edits into a structured data document specifically tailored for display on a third-party web site.

6. The network system according to claim 1, wherein:
the flattening utility is operatively configured to convert the set of collaborative edits into a HyperText Mark-up Language (HTML) document for display on a web site.

7. The network system according to claim 1, wherein:
the flattening utility is operatively configured to process the set of collaborative edits to one or more of modify or isolate code within the edits that may be harmful if included in the structured data document for viewing on a client device.

8. The network system according to claim 1, further comprising:
an updating module communicatively coupled to the rendering server and operatively configured to update the structured data document with changes to the document made after the flattening utility converts the set of collaborative edits into the structured data document.

9. The network system according to claim 7,
wherein the flattening utility further operatively configured to associate a document identification (ID) with each document pointed to by a hyperlink within the structured data document, and the updating module further operatively configured to update hyperlinks for documents that are moved within a web site.

10. A computer-implemented method that enables collaborative and scalable editing and viewing of online content, the method comprising:
receiving collaborative edits to user-created online content from multiple editors;
processing the collaborative edits using operational transformation techniques;
storing a final set of edits;
retrieving the final set of edits and converting the final set of edits into a structured data document;
storing the structured data document;
receiving a viewing request to view the structured data document via a particular client viewing device from a viewer; and
retrieving the structured data document, wherein a format of the structured data document is customized for display on the particular client viewing device.

11. The method according to claim 10, wherein:
the processing using operational transformation techniques comprises resolving conflicts between incoming collaborative edits and merging the collaborative edits into a set of edits.

12. The method according to claim 10, wherein:
the converting the final set of edits into a structured data document comprises configuring the structured data document in a format and style specifically tailored for display on the particular client device.

13. The method according to claim 10, wherein:
the converting the final set of edits into a structured data document comprises configuring the structured data document in a format and style specifically tailored for display on a particular online service.

14. The method according to claim 10, wherein:
the converting the final set of edits into a structured data document comprises configuring the structured data document in a format and style specifically tailored for display on a third-party web site.

15. The method according to claim 10, wherein:
the converting the final set of edits into a structured data document comprises converting the set of collaborative edits into a HyperText Mark-up Language (HTML) document for display on a web site.

16. The method according to claim 10, wherein:
the converting the final set of edits into a structured data document comprises one or more of modifying isolating code within the final set of edits that may be harmful if included in the structured data document for viewing on a client device.

17. The method according to claim 10, further comprising:
updating the structured data document with changes to the document made after the converting the final set of edits into the structured data document.

18. The method according to claim 17, further comprising:
associating a document identification (ID) with each document pointed to by a hyperlink within the structured data document, and updating hyperlinks for documents that are moved within a web site.

19. One or more computer-readable media storing processor-executable instructions that, when executed, cause one or more processors to perform operations that enable collaborative and scalable editing and viewing of online content, the operations comprising:
receiving collaborative edits to user-created online content from multiple editors;
processing the collaborative edits using operational transformation techniques;
storing a final set of edits;
retrieving the final set of edits and converting the final set of edits into a structured data document;
storing the structured data document;
receiving a viewing request to view the structured data document via a particular client viewing device from a viewer; and
retrieving the structured data document configured for viewing on the particular client viewing device.

20. The one or more computer readable media as recited in claim 19, wherein:
the processing using operational transformation techniques comprises resolving conflicts between incoming collaborative edits and merging the collaborative edits into a set of edits.

21. The one or more computer readable media as recited in claim 19, wherein:
the converting the final set of edits into a structured data document comprises configuring the structured data document in a format and style specifically tailored for display on the particular client device.

22. The one or more computer readable media as recited in claim 19, wherein:
the converting the final set of edits into a structured data document comprises configuring the structured data document in a format and style specifically tailored for display on a particular online service.

23. The one or more computer readable media as recited in claim 19, wherein:
the converting the final set of edits into a structured data document comprises configuring the structured data document in a format and style specifically tailored for display on a third-party web site.

24. The one or more computer readable media as recited in claim 19, wherein:
the converting the final set of edits into a structured data document comprises converting the set of collaborative edits into a HyperText Mark-up Language (HTML) document for display on a web site.

25. The one or more computer readable media as recited in claim 19, wherein:
the converting the final set of edits into a structured data document comprises processing the final set of edits to one or more of modify or isolate code within the edits that may be harmful if included in the structured data document for viewing on a client device.

26. The one or more computer readable media as recited in claim 19, the operations further comprising:
updating the structured data document with changes to the document made after the converting the final set of edits into the structured data document.

27. The one or more computer readable media as recited in claim 26, the operations further comprising:
associating a document identification (ID) with each document pointed to by a hyperlink within the structured data document, and updating hyperlinks for documents that are moved within a web site.
